(19) United States
(12) Patent Application Publication
(10) Pub. No.: US 2026/0361243 A1
(43) Pub. Date: Nov. 12, 2026

(54) ELECTROADHESIVE ATTACHMENT AND RELEASE SYSTEM (EARS) FOR UNPREPARED ATTACHMENT IN MICROGRAVITY

(71) Applicant: Cambrian Works, Inc., Los Gatos, CA (US)

(72) Inventors: Simon Tai Lee, Santa Clara, CA (US); David Frederick Smith, Ukiah, CA (US); Victor Manuel Aguero, Los Gatos, CA (US); Kalia Roseanne Crowder, Austin, TX (US)

(21) Appl. No.: 19/669,178

(22) Filed: May 6, 2026

Related U.S. Application Data
(60) Provisional application No. 63/802,891, filed on May 9, 2025.
(60) Provisional application No. 63/802,890, filed on May 9, 2025.

(51) Int. Cl. H02N 13/00

(52) U.S. Cl. CPC H02N 13/00

(57) ABSTRACT

Electroadhesive attachment and release (EAR) techniques that include an activation that includes applying a drive signal to one or more electroadhesive pads to induce electroadhesive attraction between the one or more electroadhesive pads and an opposing surface, and a release that includes modifying the drive signal to reduce electroadhesive attraction to cause release of the one or more electroadhesive pads from the opposing surface.

### RELATED APPLICATIONS

This application claims benefit of and priority to U.S. Provisional Patent Application No. 63/802,891 filed May 9, 2025 and titled “ELECTROADHESIVE ATTACHMENT AND RELEASE SYSTEMS (EARS) AND METHODS FOR UNPREPARED ATTACHMENT IN MICROGRAVITY”, and to U.S. Provisional Patent Application No. 63/802,890 filed May 9, 2025 and titled “SPACE PAYLOAD FOR INERTIAL DE-SPIN EFFICIENT EFFECTS (SPIDEE) ENABLES REPEATABLE ORBITAL DEBRIS REMEDIATION MISSIONS”, which are hereby incorporated by reference in their entireties.

### FIELD

Embodiments relate generally to systems for reversible attachment and release, and more particularly to electroadhesive attachment systems and methods adapted for use in microgravity or space-based environments.

### BACKGROUND

Microgravity — or near-zero gravity — refers to an environment in which the effects of gravitational acceleration are extremely small, typically due to continuous free-fall conditions in orbit. In these settings, objects behave as though they are weightless, and even small forces can cause persistent motion. Operations in microgravity environments differ significantly from those on Earth due to the absence of appreciable gravitational forces. Such conditions are commonly encountered aboard orbital platforms, spacecraft, and satellites. In these environments, physical interactions between objects follow different dynamics than those expected on a planet’s surface, and small forces can result in continuous motion and object drift. Various systems and activities take place under these conditions, including satellite and platform servicing, payload deployment, robotic manipulation, and astronaut-conducted assembly or repair. These operations often involve precise movements and controlled interactions between tools, modules, or structural interfaces.

### SUMMARY

In orbital and microgravity environments, conventional attachment and release methods can introduce challenges related to force application and mechanical coupling. In microgravity, attaching or detaching items using mechanical fasteners may depend on the application of force, which generates equal and opposite reaction forces. These forces can destabilize tools, platforms, or astronauts and, thus, can create a need for carefully planned and controlled rendezvous, proximity operations, docking procedures, and associated techniques. Mechanical fasteners, for example, may rely on application of physical force that generates reactionary movement — a potentially problematic outcome in free-floating conditions. Similarly, magnetic systems may lack precise control and can leave residual magnetization or may not be effective given that many materials used in spacecraft are intentionally non-magnetic. Moreover, magnetic or electromagnetic approaches may create undesirable torques or forces due to interactions with the Earth’s or ambient magnetic fields. Adhesive-based approaches are often irreversible or leave residue. Moreover, adhesives may have significant vacuum outgassing that can impart damage, generate deposition of coatings on sensitive or optical surfaces, or the like. Many existing systems rely on careful relative motion maneuvering, surface preparation, mating features or surfaces, or specific material compatibility, limiting their adaptability for on-orbit servicing or modular reconfiguration, including requiring preparations years ahead of time, frequently well before launch, to anticipate or allow for their future use.

Provided in some embodiments is an electroadhesive attachment and release system (EARS) and associated methods that may enable reversible, force-free attachment to unprepared surfaces in microgravity. In some embodiments, an EARS includes a control unit, a power drive circuit, electroadhesive pad(s) (e.g., embedded in a mounting interface), and a sensing unit, which may be optionally deployed. The system may enable surface-agnostic or material-agnostic electroadhesion that can be activated and deactivated using polarity-controlled high-voltage signals. Attachment may occur, for example, through electroadhesive attraction, and detachment may be achieved, for example, through implementation of a high-voltage power signal (e.g., without mechanical motion) — optionally incorporating reduction of residual electric fields (e.g., a varying electrical signal that changes polarity to neutralize residual attractive force, enabling faster release) or polarity reversal (e.g., used between attachment cycles to neutralize charge migration effects in the opposing surface and increase attractive force with repeated cycles). Charge migration may include, for example, both movement of change and changes in molecule polarization and molecule alignment to induce polarization fields. In some embodiments, a sensing unit is employed to monitor and report attachment quality or status. The systems and methods may, for example, be deployed in various contexts, such as robotic grippers, astronaut tools, free flying inspection craft, modular docking ports, payload retention interfaces, debris capture surfaces, surface attachments that provide armor, surface panels that change spacecraft surface properties (e.g., for specific missions or purposes), assemblies intended for detumbling space objects, or the like. By offering secure, repeatable, and residue-free engagement with a wide range of surfaces and the ability to actuate this attraction with the speed and simplicity of switching on and off electrical power, the EARS system may improve safety, efficiency, effectiveness, and flexibility for in-space operations.

Provided in some embodiments is an electroadhesive attachment and release system (EARS) including: a control unit; a power drive circuit; and one or more electroadhesive pads. In some embodiments, the control unit and power drive circuit are configured to generate and neutralize electroadhesion forces through controlled voltage delivery to the one or more electroadhesive pads. In some embodiments, the electroadhesive pads include patterned electrodes embedded within a dielectric substrate. In some embodiments, the system further includes a sensing unit configured to detect electrical signal characteristics resulting from interactions of the one or more electroadhesive pads, e.g., with a surface in close proximity or in physical contact, where the electrical signal characteristics are employed by the control unit to determine an attachment state.

Provided in some embodiments is a method of electroadhesive attachment and release, the method including: conducting an activation that includes application of a voltage to one or more electroadhesive pads; and conducting a release that includes removal of the voltage from the one or more electroadhesive pads. In some embodiments, the method further includes conducting a procedure to neutralize residual attraction forces. In some embodiments, the method further includes conducting a polarity reversal to neutralize charge migration effects.

Provided in some embodiments is an electroadhesive attachment and release system for use in a microgravity environment, including: an electroadhesive pad system including one or more pad elements, each pad element including patterned electrodes embedded within a dielectric substrate; a power drive circuit electrically coupled to the one or more pad elements; a sensing unit electrically coupled to one or more conductors associated with the one or more pad elements and adapted to detect electrical signal characteristics resulting from interactions between the one or more pad elements and an opposing surface; and a control unit coupled to the power drive circuit and the sensing unit, the control unit adapted to: cause the power drive circuit to apply a drive signal to the one or more pad elements to induce electroadhesive attraction between the electroadhesive pad system and the opposing surface; determine an attachment state based on the electrical signal characteristics; cause the power drive circuit to vary one or more characteristics of the drive signal applied to the one or more pad elements based on the attachment state to modify electroadhesive attraction between the electroadhesive pad system and the opposing surface; cause the power drive circuit to modify the drive signal to reduce electroadhesive attraction to cause release of the electroadhesive pad system from the opposing surface; cause the power drive circuit to apply an additional electrical signal to the one or more pad elements to reduce residual electric fields; and cause the power drive circuit to reverse polarity of a signal applied to the one or more pad elements before a subsequent attachment cycle.

Provided in some embodiments is an electroadhesive attachment and release system, including: a control unit; a power drive circuit; and one or more electroadhesive pads, the control unit and the power drive circuit adapted to apply a drive signal to the one or more electroadhesive pads to induce electroadhesive attraction between the one or more electroadhesive pads and an opposing surface and to modify the drive signal to reduce electroadhesive attraction to cause release of the one or more electroadhesive pads from the opposing surface.

In some embodiments, the drive signal includes a voltage and modifying the drive signal includes modifying the voltage. In some embodiments, the system further including a sensing unit electrically coupled to one or more conductors associated with the one or more electroadhesive pads and adapted to detect electrical signal characteristics resulting from interactions between the one or more electroadhesive pads and the opposing surface, where the control unit is adapted to determine an attachment state based on the electrical signal characteristics and to modify the drive signal based on the attachment state. In some embodiments, the electrical signal characteristics include: current draw, voltage response, capacitance, impedance, or contact potential. In some embodiments, modifying the drive signal includes varying a voltage level or a waveform characteristic of the drive signal. In some embodiments, the one or more electroadhesive pads include patterned electrodes embedded within a dielectric substrate. In some embodiments, the patterned electrodes are arranged as interdigitated traces of alternating polarity in a non-linear pattern. In some embodiments, the non-linear pattern includes a sawtooth pattern or a sinusoidal pattern. In some embodiments, the one or more electroadhesive pads include electrode traces and a guard ring positioned about a perimeter the electrode traces and adapted to provide a discharge current pathway. In some embodiments, the one or more electroadhesive pads include multiple pad elements arranged as a tiled system, and where the control unit and the power drive circuit are adapted to energize the pad elements in coordination to induce electroadhesive attraction between the pad elements and the opposing surface.

Provided in some embodiments is a method of electroadhesive attachment and release in a microgravity environment, including: applying, by a power drive circuit under control of a control unit, a drive signal to one or more pad elements of an electroadhesive pad system to induce electroadhesive attraction between the electroadhesive pad system and an opposing surface; detecting, by a sensing unit electrically coupled to one or more conductors associated with the one or more pad elements, electrical signal characteristics resulting from interactions between the one or more pad elements and the opposing surface; determining, by the control unit based on the electrical signal characteristics, an attachment state; varying, by the control unit, one or more characteristics of the drive signal applied to the one or more pad elements based on the attachment state to modify electroadhesive attraction between the electroadhesive pad system and the opposing surface; modifying the drive signal to reduce electroadhesive attraction to cause release of the electroadhesive pad system from the opposing surface; applying an additional electrical signal to the one or more pad elements to reduce residual electric fields; and reversing polarity of a signal applied to the one or more pad elements before a subsequent attachment cycle.

Provided in some embodiments is a method of electroadhesive attachment and release, including: conducting an activation that includes applying a drive signal to one or more electroadhesive pads to induce electroadhesive attraction between the one or more electroadhesive pads and an opposing surface; and conducting a release that includes modifying the drive signal to reduce electroadhesive attraction to cause release of the one or more electroadhesive pads from the opposing surface.

In some embodiments, modifying the drive signal includes varying a voltage level or a waveform characteristic of the drive signal. In some embodiments, the method further including detecting electrical signal characteristics associated with the one or more electroadhesive pads and determining, based on the electrical signal characteristics, an attachment state. In some embodiments, the electrical signal characteristics include: current draw, voltage response, capacitance, impedance, or contact potential. In some embodiments, the method further including modifying the drive signal based on the attachment state. In some embodiments, the method further including, responsive to determining an attachment state corresponding to attachment between the one or more electroadhesive pads and the opposing surface, conducting a hold that includes applying a hold drive signal to energize the one or more electroadhesive pads to maintain electroadhesive attraction between the one or more electroadhesive pads and the opposing surface. In some embodiments, the one or more electroadhesive pads include multiple pad elements arranged as a tiled system, and applying the drive signal includes applying one or more drive signals to energize the pad elements in coordination to induce electroadhesive attraction between the pad elements and the opposing surface. In some embodiments, the method further including applying an additional electrical signal to the one or more electroadhesive pads to reduce residual electric fields. In some embodiments, the method further including reversing polarity of a signal applied to the one or more electroadhesive pads before a subsequent attachment cycle.

### BRIEF DESCRIPTION OF THE DRAWINGS

FIG. 1 is a diagram illustrating an example electroadhesive attachment and release system (EARS) in accordance with one or more embodiments.

FIG. 2 is a sequence diagram illustrating an attachment-detachment method of the EARS system in accordance with one or more embodiments.

FIG. 3A is a diagram illustrating an example pad element in accordance with one or more embodiments.

FIG. 3B is a diagram illustrating an example tiled pad system in accordance with one or more embodiments.

FIG. 4 is a diagram illustrating an example pad having an active region defined by an area of patterned traces in accordance with one or more embodiments.

FIG. 5 is a diagram illustrating an example computer system in accordance with one or more embodiments.

While this disclosure is susceptible to various modifications and alternative forms, specific embodiments are shown by way of example in the drawings and will be described in detail. The drawings may not be to scale. It should be understood that the drawings and the detailed descriptions are not intended to limit the disclosure to the particular form disclosed, but are intended to disclose modifications, equivalents, and alternatives falling within the spirit and scope of the present disclosure as defined by the claims.

### DETAILED DESCRIPTION

Provided in some embodiments is an electroadhesive attachment and release system (EARS) and associated methods that may enable reversible, force-free attachment to unprepared surfaces in microgravity. In some embodiments, an EARS includes a control unit, a power drive circuit, electroadhesive pad(s) (e.g., embedded in a mounting interface), and a sensing unit, which may be optionally deployed. The system may enable surface-agnostic or material-agnostic electroadhesion that can be activated and deactivated using polarity-controlled high-voltage signals. Attachment may occur, for example, through electroadhesive attraction, and detachment may be achieved, for example, through implementation of a high-voltage power signal (e.g., without mechanical motion) — optionally incorporating reduction of residual electric fields (e.g., a varying electrical signal that changes polarity to neutralize residual attractive force, enabling faster release) or polarity reversal (e.g., used between attachment cycles to neutralize charge migration effects in the opposing surface and increase attractive force with repeated cycles). Charge migration may include, for example, both movement of change and changes in molecule polarization and molecule alignment to induce polarization fields. In some embodiments, a sensing unit is employed to monitor and report attachment quality or status. The systems and methods may, for example, be deployed in various contexts, such as robotic grippers, astronaut tools, free flying inspection craft, modular docking ports, payload retention interfaces, debris capture surfaces, surface attachments that provide armor, surface panels that change spacecraft surface properties (e.g., for specific missions or purposes), assemblies intended for detumbling space objects, or the like. By offering secure, repeatable, and residue-free engagement with a wide range of surfaces and the ability to actuate this attraction with the speed and simplicity of switching on and off electrical power, the EARS system may improve safety, efficiency, effectiveness, and flexibility for in-space operations.

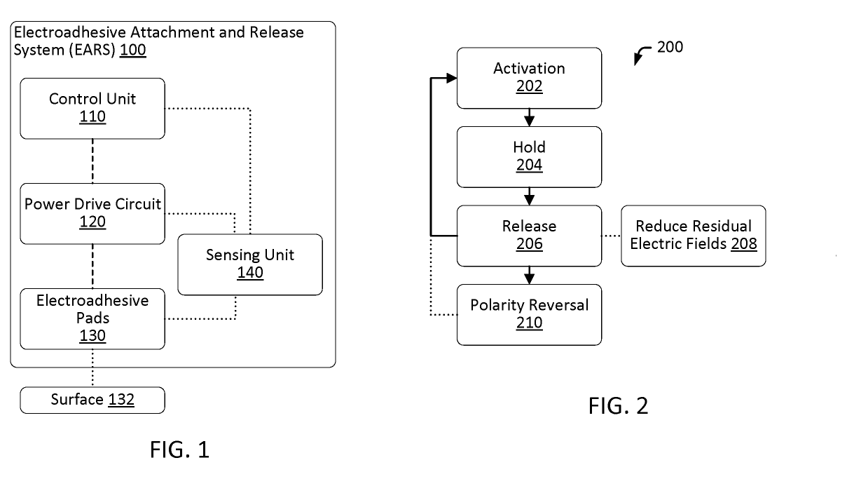

FIG. 1 is a diagram illustrating an example Electroadhesive Attachment and Release System (EARS) 100 in accordance with one or more embodiments. Such a system may be used, for example, for non-invasive, reversible attachment in microgravity. In some embodiments, system 100 includes a control unit 110, power drive circuit 120, electroadhesive pad(s) 130, and a sensing unit 140. The system 100 may generate and neutralize electrostatic adhesion forces through controlled voltage delivery to pad(s) 130. This system 100 may, for example, generate and control attraction between electroadhesive pad(s) 130 and an opposing surface 132.

In some embodiments, one or more functional elements of the EARS system 100 are integrated into a pad assembly or other mounting structure. For example, one or more portions of control unit 110, power drive circuit 120, sensing unit 140, or associated interconnects may be carried by an assembly configured as a panel, layer, or sheath on a host structure. In some embodiments, one or more of control unit 110, power drive circuit 120, or sensing unit 140 are implemented in separate subsystems located remotely from electroadhesive pads 130. For example, the control unit 110 and power drive circuit 120 may be distributed within a spacecraft or other platform to accommodate packaging, mass distribution, thermal management, or harness-routing considerations.

### Electroadhesive Pad(s)

In some embodiments, electroadhesive pad(s) 130 include patterned conductive electrodes embedded within a dielectric layer. For example, an electroadhesive pad 130 may include electrodes formed of electrical traces embedded within or carried by a dielectric material. When a voltage differential is applied across the electrodes, an electric field is generated that produces attraction between the pad 130 and an opposing surface. For example, a robotic manipulator, docking interface, or tool may carry the electroadhesive pad 130 and, in response to a control signal, energize the electroadhesive pad 130 to attach to a metallic or non-metallic surface. This may be provided, for example, using the resulting electroadhesive attraction, without relying on hooks, clamps, magnets, or residue-producing adhesives. In some embodiments, the electroadhesive pad 130 adheres to an opposing surface without requiring a specific coating, treatment, or mating feature on the opposing surface.

In some embodiments, an electroadhesive pad 130 is relatively thin, is formed of space-rated materials, is mounted on a baseplate, or is flexible and conformable to irregular surfaces. For example, the electroadhesive pad 130 may be less than about 0.1 mm thick, may be carried by an aluminum baseplate, and may have an active area of about 40 mm x 40 mm, about 80 mm x 80 mm, or another selected size. Adhesion force may generally increase with active area. In some embodiments, the electroadhesive pad 130 is flexible and conforms to a non-planar surface. For example, the electroadhesive pad 130 may drape over an irregular surface such that both normal forces and shear forces contribute to attachment.

In some embodiments, one or more surfaces of the electroadhesive pad 130 include a protective coating adapted to reduce chemical, collisional, or plasma-driven degradation in a space environment. For example, dielectric surfaces of the electroadhesive pad 130 may carry a silicon oxide coating, a Parylene coating, or another passivation layer that reduces atomic oxygen interaction, improves electrical breakdown performance, or reduces surface erosion. In some embodiments, such coatings are employed in low Earth orbit or in another orbital or space environment.

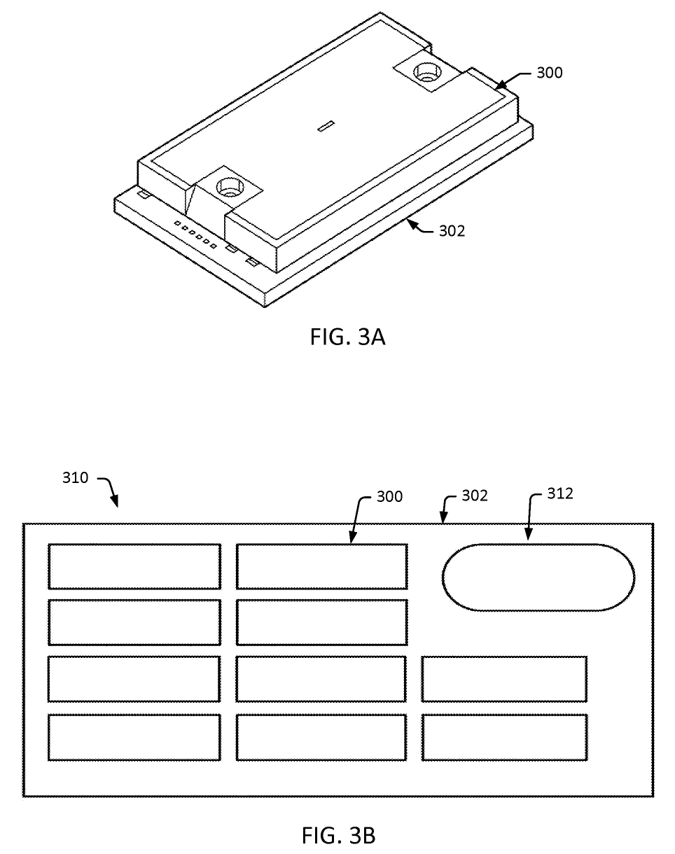

In some embodiments, pads 130 are provided as multiple pad elements arranged as a tiled system, as illustrated in FIGS. 3A and 3B. FIG. 3A is a diagram illustrating an example pad element 300 in accordance with one or more embodiments. It illustrates an example pad element 300 carried by a substrate 302. FIG. 3B is a diagram illustrating an example tiled pad system in accordance with one or more embodiments. It illustrates an example tiled pad system 310 including multiple pad elements 300 arranged on a common substrate 302. In some embodiments, the substrate 302 also carries controller system 312 or other components, such as interconnects, or other functional sensors or subsystems. For example, the pad elements 300 may be energized independently, energized in groups, or energized in unison to vary adhesion force, contact behavior, or power draw. In some embodiments, the control unit 110 and the power drive circuit 120 energize the pad elements 300 in coordination. This may include energizing different pad elements 300 with different voltage levels, waveform characteristics, duty cycles, timings, or polarities relative to each other based on position of the pad elements 300 within the tiled pad system 310, sensed proximity or contact of respective pad elements 300, attachment quality associated with respective regions of the tiled pad system 310, or loading acting on the tiled pad system 310. For example, the control unit 110 may cause the power drive circuit 120 to increase energization of a first subset of pad elements 300 while maintaining or reducing energization of a second subset of pad elements 300 to vary electroadhesive attraction across different regions of the tiled pad system 310. As an example, when sensing information indicates partial contact at an edge region of the tiled pad system 310 and stable contact at a central region of the tiled pad system 310, the control unit 110 may cause the power drive circuit 120 to increase a voltage level, duty cycle, or other waveform characteristic applied to edge pad elements 300 and maintain or reduce a voltage level, duty cycle, or other waveform characteristic applied to central pad elements 300 to establish or maintain attachment while managing power consumption. In some embodiments, one or more pad elements 300 are movable relative to other pad elements 300 to accommodate local surface contour or irregularity.

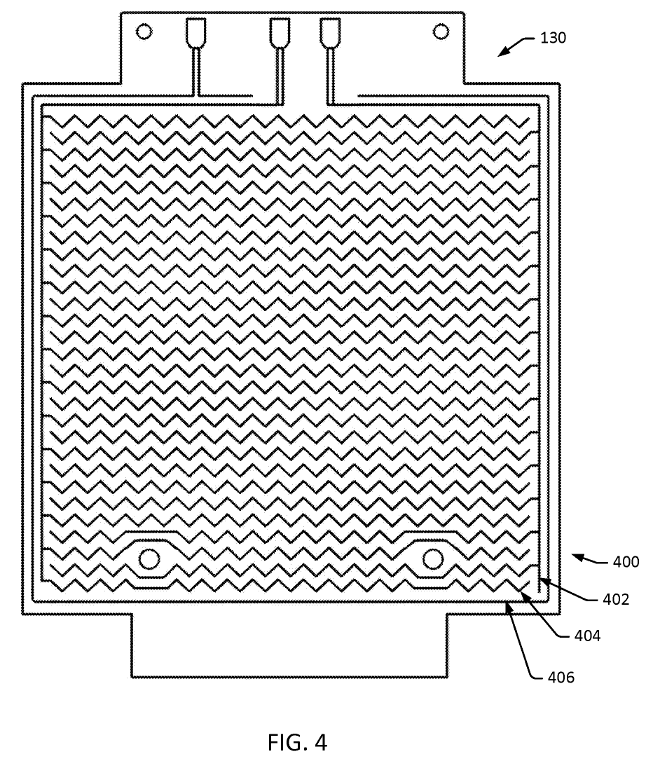

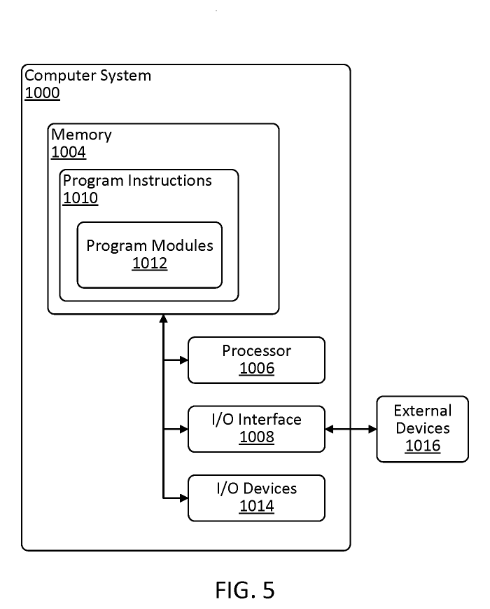

In some embodiments, an electroadhesive pad 130 includes an active region defined by patterned traces, as illustrated in FIG. 4. FIG. 4 is a diagram illustrating an example pad 130 having an active region 400 defined by an area of patterned traces 402 and 404 in accordance with one or more embodiments. In some embodiment, different voltages are applied to each of the patterned traces 402 and 404. This may achieve electric fields between the traces 402 and 404. In some embodiments, the traces are electrically isolated and disposed in suitable patterns. For example, the patterned traces 402 and 404 may be arranged as interdigitated traces of alternating polarity in a sawtooth pattern, a sinusoidal pattern, or another non-linear pattern. In some embodiments, such patterns reduce alignment sensitivity between field-generating regions and features of a mating surface. For example, where the electroadhesive pad 130 is used to attach to an elongated, irregular, or variably oriented surface, a non-linear trace pattern may provide more consistent attachment performance across different relative orientations.

In some embodiments, an electroadhesive pad 130 includes one or more traceless regions where electroadhesive traces are omitted. For example, a traceless region may be reserved for an alignment feature, a mounting feature, a sensing component, or an interface that transfers data, power, thermal energy, or fluids. Although omission of traces may reduce active electroadhesive area, such regions may permit additional interface functionality without preventing the electroadhesive pad 130 from providing electroadhesive attraction. For example, optical, electrical, inductive, capacitive, thermal, or fluid interfaces may extend through or across such regions.

In some embodiments, an electroadhesive pad 130 includes a guard structure 406 disposed around the active region including the traces 402 and 404, which may each be electrically isolated and carry different voltages. For example, the guard structure 406 may include a guard ring, such as a grounding ring that extends completely or substantially about the patterned traces 402 and 404, e.g., encircling 75%, 80%, 90%, 95% or more of their perimeter, to route discharge currents encountered during contact between surfaces and to limit extension of electric fields outside the active region that includes the traces 402 and 404. For example, in the illustrated embodiment, the guard structure 406 includes a generally square-shaped conductive ring that extends about the generally square-shaped active region 400 defined by the patterned traces 402 and 404. Such a guard structure may reduce interaction with surrounding sensors, plasma, or other environmental features and may help protect the control unit 110 or the power drive circuit 120 from discharge events. In some embodiments, the guard structure is employed in a low plasma density, high vacuum, or other space environment where differential charging or field extension may be of concern. In some embodiments, the guard structure 406 serves as a discharge current pathway, such as when differentially charged surfaces in space come into contact or to contain the fields of the active electrodes to the active region within the general perimeter of the guard electrode. In some embodiments, the guard structure 406 serves as a reference electrode to limit the active trace fields penetrating outside the active region of the electroadhesive pad 130.

### Control Unit and Power Drive Circuit:

In some embodiments, the control unit 110 includes logic circuitry configured to control an electroadhesive attachment cycle. For example, the control unit 110 may receive control signals from an external controller, such as a robotic system, spacecraft controller, or astronaut command interface, or may issue control signals based on a detected system state. In some embodiments, the control unit 110 controls timing, polarity, sequencing, or duration of signals applied to electroadhesive pad(s) 130. For example, the control unit 110 may control activation, hold, release, residual field reduction, or polarity reversal operations.

In some embodiments, the power drive circuit 120 supplies high-voltage outputs to electroadhesive pad(s) 130. For example, power drive circuit 120 may receive a lower-voltage electrical input and generate a higher-voltage output for delivery to one or more electroadhesive pad(s) 130. In some embodiments, the lower-voltage input is about 5 volts to about 28 volts direct current (DC), and the higher-voltage output is about 700 volts to about 3000 volts or about ±1500 volts DC. In some embodiments, the power drive circuit 120 employs an H-bridge, a boost converter, a transformer-based multiplier, or another suitable topology. For example, the power drive circuit 120 may include one or more voltage-conversion stages and switching elements arranged to generate and selectively apply a high-voltage differential to electroadhesive pad(s) 130. In some embodiments, the power drive circuit 120 provides a relatively low-current, high-voltage output to a single electroadhesive pad 130, to multiple electroadhesive pads 130, or to multiple tiled pad elements.

In some embodiments, the control unit 110 and the power drive circuit 120 control electrical waveform characteristics to affect approach, attachment, holding, or release behavior. For example, during an approach operation, the control unit 110 may cause the power drive circuit 120 to energize an electroadhesive pad 130 such that the resulting field creates a short-range attractive force between the pad 130 and an opposing surface. In some embodiments, the control unit 110 adjusts waveform characteristics, such as voltage level, polarity, polarity-reversal timing, frequency, duty cycle, pulse width, rise time, fall time, waveform shape, or signal duration, to vary attractive force, attachment timescale, or release characteristics. For example, a first set of waveform characteristics may be selected for a conductive surface and a second set of waveform characteristics may be selected for a dielectric surface. The first set of waveform characteristics may include, for example, a first voltage level, pulse width, rise time, or duty cycle adapted for response of the conductive surface, while the second set of waveform characteristics may include, for example, a second voltage level, pulse width, rise time, or duty cycle adapted for response of the dielectric surface.

In some embodiments, the control unit 110 determines proximity, attachment quality, separation behavior, or changing load conditions based on electrical signal characteristics associated with one or more electroadhesive pads 130 and controls operation of the EARS system 100 based on the determination. This may include measuring current draw associated with an electroadhesive pad 130, measuring a voltage response associated with the electroadhesive pad 130, determining capacitance, impedance, or another electrical circuit characteristic based on the measured current draw or voltage response, and comparing the measured or determined electrical characteristic to one or more expected values or ranges associated with approach, contact, partial contact, separation, or changing dynamic loading. For example, when the measured current draw or voltage response indicates increasing capacitance associated with increasing surface proximity or contact area, the control unit 110 may determine that attachment is increasing and may cause the power drive circuit 120 to maintain an applied field, reduce an approach rate, or transition from an approach operation to a hold operation. In another example, when the measured current draw, voltage response, capacitance, or impedance indicates reduced contact area, partial separation, or changing dynamic loads between attached bodies, the control unit 110 may determine that attachment quality has degraded and may cause the power drive circuit 120 to increase field strength, alter waveform characteristics, energize one or more additional electroadhesive pads 130, or initiate a release or reattachment operation.

In some embodiments, the control unit 110 and the power drive circuit 120 vary the number of energized electroadhesive pads 130, the number of energized pad elements, the voltage level applied to one or more electroadhesive pads 130, or one or more waveform characteristics of an applied drive signal to manage power consumption while maintaining attachment. This may include determining, based on current draw, voltage response, capacitance, impedance, or other electrical signal characteristics associated with one or more electroadhesive pads 130, whether reduced or increased attachment force is appropriate for present operating conditions. For example, when the electrical signal characteristics indicate reduced relative motion, vibration, or loading, the control unit 110 may cause the power drive circuit 120 to reduce the voltage applied to an electroadhesive pad 130, de-energize one or more selected electroadhesive pads 130, de-energize one or more selected pad elements of a tiled pad system in coordination, or modify waveform characteristics of an applied drive signal, such as by reducing duty cycle, while maintaining sufficient electroadhesive attraction. In some embodiments, the control unit 110 and the power drive circuit 120 actively adjust attachment force to compensate for changing loads, motion, or other dynamic conditions between attached bodies. For example, when the electrical signal characteristics indicate relative motion, vibration, or increased loading, the control unit 110 may cause the power drive circuit 120 to increase the voltage level applied to an electroadhesive pad 130, energize one or more additional electroadhesive pads 130 or pad elements, or modify waveform characteristics of an applied drive signal, such as by increasing duty cycle, to increase attachment force and maintain sufficient electroadhesive attraction. When the electrical signal characteristics indicate that the relative motion, vibration, or increased loading has been reduced, the control unit 110 may cause the power drive circuit 120 to reduce the applied voltage, de-energize one or more pads 130 or pad elements, or modify the waveform characteristics to reduce power consumption while maintaining attachment.

In some embodiments, the control unit 110 and the power drive circuit 120 are configured for operation in vacuum, low-pressure, or plasma environments and control operation of the EARS system 100 based on one or more environmental conditions or protection conditions. This may include selecting voltage levels, waveform characteristics, current limits, isolation settings, or discharge-protection settings based on an operating environment, such as low Earth orbit, geosynchronous orbit, or another space environment, and routing or limiting discharge current associated with contact between surfaces. For example, when the EARS system 100 is operated in an environment having expected differential charging, plasma interaction, or discharge risk, the control unit 110 may cause the power drive circuit 120 to apply a selected waveform, a selected current limit, or a selected protection setting adapted for that environment, and the power drive circuit 120 may cooperate with the guard structure 406 of an electroadhesive pad 130 to route discharge current or limit extension of electric fields outside the active region 400 defined by the electrode traces 402 and 404. In some embodiments, the power drive circuit 120 includes current limiting, isolation, discharge protection, or other circuit protection features to reduce effects of arcing or other discharge events.

### Attachment Cycle:

FIG. 2 is a sequence diagram illustrating an attachment-detachment method 200 of the EARS system in accordance with one or more embodiments. In some embodiments, the attachment-detachment method 200 includes a cycle of activation, hold, release, optional reduction of residual electric fields, and optional polarity reversal.

In some embodiments, the attachment-detachment method 200 includes activation (block 202). This may include application of a voltage to one or more electroadhesive pads 130 to, for example, induce electroadhesive attraction between the one or more electroadhesive pads 130 and an opposing surface. For example, this may include the control unit 110 causing the power drive circuit 120 to apply a selected voltage level, polarity, waveform, or other drive signal to an electroadhesive pad 130 as the pad 130 approaches the opposing surface. As an example, as a robotic manipulator, docking interface, or other host structure brings the pad 130 toward a target surface, the control unit 110 may cause the power drive circuit 120 to energize the pad 130 using waveform characteristics selected for the target surface such that the resulting field draws the pad 130 into contact with the target surface and establishes attachment with reduced contact force.

In some embodiments, the attachment-detachment method 200 includes holding (block 204). This may include maintaining attachment between the one or more electroadhesive pads 130 and the opposing surface, for example, by continuing to energize the one or more electroadhesive pads 130. For example, this may include maintaining continuous voltage application, varying voltage level, or modifying one or more waveform characteristics of an applied drive signal while maintaining sufficient electroadhesive attraction. As an example, after attachment is established, the control unit 110 may cause the power drive circuit 120 to maintain a selected hold voltage on an electroadhesive pad 130, reduce the hold voltage, or duty cycle the applied drive signal to reduce power consumption while maintaining attachment. When current draw, voltage response, capacitance, impedance, or other electrical signal characteristics indicate reduced contact area, relative motion, vibration, or increased loading, the control unit 110 may cause the power drive circuit 120 to increase the applied voltage, alter waveform characteristics, or energize one or more additional electroadhesive pads 130 or pad elements to maintain attachment.

In some embodiments, the attachment-detachment method 200 includes release (block 206). This may include removal, reduction, or discontinuation of the voltage applied to the one or more electroadhesive pads 130 to, for example, reduce electroadhesive attraction between the one or more electroadhesive pads 130 and the opposing surface. For example, this may include the control unit 110 causing the power drive circuit 120 to discontinue a hold voltage, reduce the applied voltage to a level insufficient to maintain attachment, or apply a release waveform adapted to reduce electroadhesive attraction. As an example, after servicing, manipulation, or docking is complete, the control unit 110 may cause the power drive circuit 120 to discontinue or reduce the applied field to an electroadhesive pad 130 such that the pad 130 separates from the opposing surface.

In some embodiments, the attachment-detachment method 200 includes reducing residual electric fields (block 208). This may include reducing residual electric fields or other residual attraction forces remaining after the release operation. For example, this may include the control unit 110 causing the power drive circuit 120 to apply an additional electrical signal that changes polarity, decays in amplitude, or otherwise varies over time to reduce residual charge or polarization associated with an electroadhesive pad 130 or the opposing surface. As an example, after a hold voltage is removed, the control unit 110 may cause the power drive circuit 120 to apply one or more alternating, oscillating, or decaying pulses to the pad 130 to neutralize residual attractive forces and promote faster or cleaner separation.

In some embodiments, the attachment-detachment method 200 includes polarity reversal (block 210). This may include reversing polarity between successive attachment cycles to, for example, reduce charge migration effects or maintain attachment performance over repeated cycles. For example, this may include the control unit 110 causing the power drive circuit 120 to reverse polarity of a signal applied to an electroadhesive pad 130 after a release operation and before a subsequent activation operation. As an example, after a first attachment and release cycle, the control unit 110 may cause the power drive circuit 120 to apply a reversed-polarity signal to the pad 130 to reduce charge accumulation or migration at the opposing surface and improve consistency of a subsequent attachment operation.

In an example use case, a free-flying robotic servicing vehicle may approach a satellite lacking a prepared docking port and may carry one or more electroadhesive pads 130 at a docking interface. During activation, the control unit 110 may cause the power drive circuit 120 to energize the one or more electroadhesive pads 130 such that the docking interface attaches to an outer panel of the satellite with reduced contact force. During hold, the control unit 110 may cause the power drive circuit 120 to maintain or adjust an applied field while the vehicle performs servicing, repositioning, or other operations. During release, the control unit 110 may cause the power drive circuit 120 to reduce or discontinue the applied field, and may optionally perform residual field reduction or polarity reversal, such that the docking interface detaches and the vehicle repositions for a subsequent operation.

### Sensing Unit:

In some embodiments, the sensing unit 140 provides sensing information associated with approach, contact, attachment quality, separation behavior, or changing dynamic loading of one or more electroadhesive pads 130. This may include measuring current draw, voltage response, capacitance, impedance, contact potential, or another electrical characteristic associated with an electroadhesive pad 130 and providing corresponding sensing information to the control unit 110. For example, the sensing unit 140 may measure current or voltage at an electroadhesive pad 130, determine capacitance or impedance based on the measured current or voltage, and provide corresponding sensing information to the control unit 110 for use in controlling activation, hold, release, residual field reduction, or polarity reversal operations. In some embodiments, the sensing unit 140 is integrated into a pad assembly, the control unit 110, the power drive circuit 120, or a separate sensing subsystem.

In some embodiments, the sensing unit 140 is electrically coupled to one or more conductors associated with an electroadhesive pad 130. This may include coupling to one or more electrodes or traces of the electroadhesive pad 130, one or more interconnects between the electroadhesive pad 130 and the power drive circuit 120, one or more output nodes of the power drive circuit 120, or one or more sense nodes of the control unit 110 or the power drive circuit 120 that are electrically representative of current draw, voltage response, capacitance, impedance, contact potential, or another electrical characteristic associated with the electroadhesive pad 130. For example, the sensing unit 140 may include one or more sense leads coupled to the drive path of an electroadhesive pad 130 to measure current or voltage at the pad 130, or may share one or more drive conductors with the power drive circuit 120 and derive sensing information from signals measured at an output of the power drive circuit 120.

In some embodiments, the control unit 110 determines an attachment state based on sensing information from the sensing unit 140. This may include comparing measured current draw, voltage response, capacitance, impedance, contact potential, or another electrical characteristic provided by the sensing unit 140, to one or more expected values or ranges associated with approach, contact, partial contact, full attachment, separation, or changing dynamic loading. For example, when sensed current draw or voltage response indicates increasing capacitance associated with increasing surface proximity or contact area, the control unit 110 may determine that an opposing surface is approaching an electroadhesive pad 130 or that attachment is increasing. As an example, when sensed current draw after activation remains below an expected range, or when sensed impedance indicates reduced contact area or partial separation, the control unit 110 may determine that incomplete contact, failed adhesion, degraded attachment, or separation is present.

In some embodiments, the control unit 110 controls operation of the EARS system 100 based on the determined attachment state. This may include continuing an approach operation, transitioning from activation to hold, increasing or reducing applied voltage, modifying waveform characteristics, energizing one or more additional electroadhesive pads 130 or pad elements, initiating an autonomous retry procedure, generating an alert, or initiating a fallback or release operation. For example, when the control unit 110 determines that attachment is increasing, the control unit 110 may continue activation or transition to hold. As an example, when the control unit 110 determines that degraded attachment, partial separation, relative motion, vibration, or increased loading is present, the control unit 110 may cause the power drive circuit 120 to increase field strength, alter waveform characteristics, energize one or more additional electroadhesive pads 130 or pad elements, or initiate a release or reattachment operation.

In some embodiments, the sensing unit 140 determines one or more status indications based on the measured electrical characteristics and provides the determined status indications to the control unit 110. This may include the sensing unit 140 generating a signal, flag, message, or other output indicating approach, contact, full attachment, partial attachment, degraded attachment, separation, or a fault condition. For example, the sensing unit 140 may compare measured current draw or voltage response to one or more threshold values or ranges and provide to the control unit 110 a status indication that attachment has been established, that attachment is degraded, or that attachment has failed. As an example, the control unit 110 may use the status indication from the sensing unit 140 in place of, or in addition to, raw sensing information to control the EARS system 100.

In some embodiments, the sensing unit 140 provides feedback regarding attachment without requiring a separate mechanical contact sensor or force sensor at the attachment interface. This may include using sensed electrical behavior of an electroadhesive pad 130 and associated circuitry to infer attachment-related conditions. For example, during docking of a free-flying robotic servicing vehicle to a satellite surface, the sensing unit 140 may monitor current draw and voltage response of one or more electroadhesive pads 130 during approach and hold, and the control unit 110 may use the resulting sensing information or determined status indications to transition between activation, hold, retry, and release operations. As an example, when attachment is not established within an expected time after activation, the control unit 110 may initiate an autonomous retry procedure, modify waveform characteristics, energize additional electroadhesive pads 130, or generate an alert for operator review.

### Example operation:

In some embodiments, the EARS system 100 performs an attachment and release operation using multiple electroadhesive pads 130 or multiple pad elements 300 of a tiled pad system 310. This may include approaching a target surface, activating a first set of pad elements 300 to initiate electroadhesive attraction, using sensing information from the sensing unit 140 to detect increasing proximity or contact, transitioning from activation to hold after attachment is established, varying voltage level, waveform characteristics, or the number of energized pads 130 or pad elements 300 during hold based on sensed attachment conditions, releasing attachment by reducing or discontinuing applied voltage, reducing residual electric fields, and performing polarity reversal before a subsequent attachment cycle.

For example, a free-flying servicing vehicle may carry a tiled pad system 310 at a docking interface and may approach an exterior panel of a resident space object. As the docking interface approaches the exterior panel, the control unit 110 may cause the power drive circuit 120 to energize a first subset of pad elements 300 at a first voltage level and with first waveform characteristics selected for the target surface. The sensing unit 140 may measure current draw and voltage response associated with the energized pad elements 300 and provide corresponding sensing information to the control unit 110. When the sensing information indicates increasing capacitance associated with decreasing separation between the tiled pad system 310 and the exterior panel, the control unit 110 may determine that approach is progressing and may continue the activation operation. When the sensing information indicates that contact has occurred across an increased contact area, the control unit 110 may cause the power drive circuit 120 to energize additional pad elements 300 or increase the applied voltage to establish attachment across the tiled pad system 310.

After attachment is established, the control unit 110 may use sensing information from the sensing unit 140 to determine whether full attachment, partial attachment, degraded attachment, or increased loading is present. When the sensing information indicates stable attachment and reduced relative motion, the control unit 110 may cause the power drive circuit 120 to reduce the hold voltage, de-energize selected pad elements 300, or reduce duty cycle while maintaining sufficient electroadhesive attraction. In some embodiments, the control unit 110 coordinates energization of different pad elements 300 based on respective sensed attachment conditions associated with different regions of the tiled pad system 310. For example, the control unit 110 may cause the power drive circuit 120 to increase a voltage level, duty cycle, or other waveform characteristic applied to a first subset of pad elements 300 while maintaining or reducing a voltage level, duty cycle, or other waveform characteristic applied to a second subset of pad elements 300 to vary electroadhesive attraction across the tiled pad system 310. When the sensing information indicates reduced contact area, vibration, or increased loading, the control unit 110 may cause the power drive circuit 120 to increase the applied voltage, modify waveform characteristics, or energize one or more additional pad elements 300 to maintain attachment. After docking, servicing, or repositioning is complete, the control unit 110 may cause the power drive circuit 120 to reduce or discontinue the applied voltage to release the tiled pad system 310 from the exterior panel, apply one or more decaying or alternating signals to reduce residual electric fields, and apply a reversed-polarity signal before a subsequent attachment operation to reduce charge migration effects and improve consistency of a later attachment cycle. As described, charge migration may include, for example, both movement of change and changes in molecule polarization and molecule alignment to induce polarization fields.

### Example Embodiments:

In some embodiments, the EARS system 100 is adapted to different scales and operational profiles. This may include implementing one or more electroadhesive pads 130 as a multi-panel array for higher-mass docking or attachment operations, as a miniaturized pad assembly for CubeSats, compact robotic tools, or confined-space operations, or as a pad assembly operated using selected voltage drive schemes for different power budgets or orbital environments. For example, a multi-panel electroadhesive array may be carried by a servicing platform and used to attach a scientific instrument to a structural truss or a large spacecraft hull, while a miniaturized configuration may be carried by a compact robotic tool, an astronaut-operated device, or a CubeSat and operated using waveform characteristics selected for a particular mission constraint, such as a low-power mode, a confined-space attachment operation, a low Earth orbit operation, or a geosynchronous orbit operation.

In some embodiments, the EARS system 100 is used to attach, repair, augment, or replace surface or structural elements of a spacecraft or other platform. This may include reversibly attaching internal or external skin panels, repair panels, protective panels, thermal-control panels, optical or radar-signature modifying panels, or other modular surface elements to a host structure without requiring a preprepared mechanical attachment interface. For example, a damaged exterior panel may be covered or replaced by an electroadhesively attached panel, a vehicle may carry a first set of surface panels adapted for heat shielding during one mission phase and a second set of panels adapted for thermal radiation during another mission phase, or a platform may carry one or more electroadhesively attached panels having selected optical, thermal, spectral, or radar properties for a selected mission operation. In some embodiments, electroadhesion between such surface or structural elements may also increase persistence or rigidity of an assembly while power is applied.

In some embodiments, the EARS system 100 provides attachment interfaces for mobile robotic units or localized field interactions prior to full attachment. This may include attaching electroadhesive pads 130 to feet, treads, grippers, crawlers, or other robotic contact structures, or energizing an electroadhesive pad 130 to create a localized attractive field that assists approach, positioning, or fine attitude adjustment before full contact occurs. For example, a robotic unit may traverse an interior or exterior spacecraft surface using pads 130 as reversible traction interfaces, a robotic gripper may attract an object before the object can bounce away in a microgravity environment, or a servicing vehicle may energize a pad 130 during close approach to provide a localized field that assists fine positioning relative to a target surface before an attachment operation is completed.

In some embodiments, the EARS system 100 provides reversible, clean attachment without requiring mechanical clamping, hooks, screws, straps, or residue-producing adhesives and without requiring surface pre-treatment. This may include attaching to a broad set of materials using electroadhesive attraction while reducing reaction forces that would otherwise complicate robotic or astronaut operations in microgravity. For example, the EARS system 100 may attach to a metallic or non-metallic surface, disengage without leaving residue, and avoid the outward-facing discontinuities associated with mechanical fasteners that could otherwise change thermal, optical, spectral, or radar-related surface properties or create gaps through which heat, radiation, or debris may penetrate.

In some embodiments, the EARS system 100 improves reliability, modularity, or operational flexibility by integrating attachment sensing, by supporting multiple high-voltage drive schemes, or by allowing repeated use without substantial mechanical wear. This may include using the sensing unit 140 to provide attachment-state information without a separate mechanical contact sensor, selecting voltage level or waveform characteristics based on mission constraints, and repeatedly attaching and releasing one or more electroadhesive pads 130 without the wear associated with mechanical interfaces. For example, the control unit 110 may use sensing information to detect degraded attachment and increase electroadhesive attraction, while the power drive circuit 120 uses a selected drive scheme adapted for a given power budget, orbital regime, or target surface condition.

In some embodiments, electroadhesive attraction provided by the EARS system 100 is used to create or enhance structural persistence, capture capability, or energy dissipation between components. This may include reversibly attaching structural elements to form a more rigid assembly, attracting components separated by a gap to bring the components into contact without external pushing forces, retaining or detumbling a free-spinning object, or increasing drag or friction at an interface to remove energy from a moving or spinning object. For example, electroadhesive pads 130 may be carried on structural members of a truss to hold the members in a rigid assembly while power is applied, may be carried on a robotic gripper to attract an object before the object can bounce away in microgravity, may bring opposed surfaces of a thermal switch into and out of contact, or may be brought into contact with a moving or spinning resident space object to increase friction or drag and assist in de-spinning the object.

In some embodiments, the EARS system 100 includes or is coupled to a power subsystem adapted to supply operating power to the power drive circuit 120. This may include a self-powered variation that leverages ambient energy sources, such as solar power, thermal gradients, or radiative decay, without requiring a separate dedicated power-storage subsystem. For example, a compact EARS payload may harvest solar power during an attachment or servicing mission and use the harvested power to operate the power drive circuit 120 and associated control electronics.

In some embodiments, the EARS system 100 is used to retain tools, components, or other objects at a workspace surface in a space or terrestrial environment. This may include providing a work surface on which objects remain where placed despite vibration, centripetal acceleration, or other environmental forces. For example, an astronaut work surface, a robotic maintenance platform, or another mobile workspace may include electroadhesive pads 130 that hold tools or components in place until selectively released.

In some embodiments, the EARS system 100 is used to augment a resident space object or other platform with additional payload capability. This may include attaching propulsion modules, attitude-control modules, sensing payloads, communications payloads, structural modules, or other functional packages to a spacecraft or resident space object that lacks a preprepared attachment interface. For example, an unstable or tumbling resident space object may be electroadhesively attached to a payload providing propulsion or attitude control such that the object is adapted for later servicing, relocation, stabilization, or other mission operations.

In some embodiments, the EARS system 100 is used as a debris-capture or debris-control interface. This may include attracting or retaining fragments or fragile surface material generated during docking, attachment, servicing, or robotic operations. For example, one or more electroadhesive pads 130 may be positioned adjacent a workspace or docking region to attract or retain fragments from a deteriorated thermal blanket, coating, or other surface material during a servicing operation.

In some embodiments, the EARS system 100 is used in a mechanism having first and second states associated with active and inactive electroadhesion. This may include varying friction between surfaces that move relative to one another to vary energy dissipation. For example, a variable damping mechanism may include opposing surfaces having an electroadhesive interface, where activation of electroadhesion increases frictional coupling and deactivation reduces frictional coupling.

FIG. 5 is a diagram illustrating an example computer system (or “system”) 1000 in accordance with one or more embodiments. System 1000 may include a memory 1004, a processor 1006 and an input/output (I/O) interface 1008. Memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). Memory 1004 may include a non-transitory computer-readable storage medium having program instructions 1010 stored on the medium. Program instructions 1010 may include, for example, program modules 1012 that are executable by a computer processor (e.g., processor 1006) to cause the functional operations described, such as those described with regard to the control unit 110, the sensing unit 140, or the attachment-detachment method 200.

Processor 1006 may be any suitable processor capable of executing program instructions. Processor 1006 may include one or more processors that carry out program instructions (e.g., the program instructions of program modules 1012) to perform the arithmetical, logical, or input/output operations described. Processor 1006 may include multiple processors that can be grouped into one or more processing cores that each include a group of one or more processors that are used for executing the processing described here. I/O interface 1008 may provide an interface for communication with one or more I/O devices 1014, such as a joystick, a computer mouse, a keyboard, or a display screen (e.g., an electronic display for displaying a graphical user interface (GUI)). I/O devices 1014 may include one or more of the user input devices. I/O devices 1014 may be connected to I/O interface 1008 by way of a wired connection (e.g., an Industrial Ethernet connection) or a wireless connection (e.g., a Wi-Fi connection). I/O interface 1008 may provide an interface for communication with one or more external devices 1016, computer systems, servers or electronic communication networks. In some embodiments, I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. An electroadhesive attachment and release system for use in a microgravity environment, comprising:
an electroadhesive pad system comprising one or more pad elements, each pad element comprising patterned electrodes embedded within a dielectric substrate;
a power drive circuit electrically coupled to the one or more pad elements;
a sensing unit electrically coupled to one or more conductors associated with the one or more pad elements and configured to detect electrical signal characteristics resulting from interactions between the one or more pad elements and an opposing surface; and
a control unit coupled to the power drive circuit and the sensing unit, the control unit configured to:
cause the power drive circuit to apply a drive signal to the one or more pad elements to induce electroadhesive attraction between the electroadhesive pad system and the opposing surface;
determine an attachment state based on the electrical signal characteristics;
cause the power drive circuit to vary one or more characteristics of the drive signal applied to the one or more pad elements based on the attachment state to modify electroadhesive attraction between the electroadhesive pad system and the opposing surface;
cause the power drive circuit to modify the drive signal to reduce electroadhesive attraction to cause release of the electroadhesive pad system from the opposing surface;
cause the power drive circuit to apply an additional electrical signal to the one or more pad elements to reduce residual electric fields; and
cause the power drive circuit to reverse polarity of a signal applied to the one or more pad elements before a subsequent attachment cycle.

2. An electroadhesive attachment and release system, comprising:
a control unit;
a power drive circuit; and
one or more electroadhesive pads,
the control unit and the power drive circuit configured to apply a drive signal to the one or more electroadhesive pads to induce electroadhesive attraction between the one or more electroadhesive pads and an opposing surface and to modify the drive signal to reduce electroadhesive attraction to cause release of the one or more electroadhesive pads from the opposing surface.

3. The system of claim 2, wherein the drive signal comprises a voltage and modifying the drive signal comprises modifying the voltage.

4. The system of claim 2, further comprising a sensing unit electrically coupled to one or more conductors associated with the one or more electroadhesive pads and configured to detect electrical signal characteristics resulting from interactions between the one or more electroadhesive pads and the opposing surface, wherein the control unit is configured to determine an attachment state based on the electrical signal characteristics and to modify the drive signal based on the attachment state.

5. The system of claim 4, wherein the electrical signal characteristics comprise: current draw, voltage response, capacitance, impedance, or contact potential.

6. The system of claim 4, wherein modifying the drive signal comprises varying a voltage level or a waveform characteristic of the drive signal.

7. The system of claim 2, wherein the one or more electroadhesive pads comprise patterned electrodes embedded within a dielectric substrate.

8. The system of claim 7, wherein the patterned electrodes are arranged as interdigitated traces of alternating polarity in a non-linear pattern.

9. The system of claim 8, wherein the non-linear pattern includes a sawtooth pattern or a sinusoidal pattern.

10. The system of claim 2, wherein the one or more electroadhesive pads comprise:
electrode traces; and
a guard ring positioned about the electrode traces.

11. The system of claim 10, wherein the guard ring is configured to provide a discharge current pathway or to provide a reference electrode configured to limit active trace fields penetrating outside an active region of the electroadhesive pad.

12. The system of claim 2, wherein the one or more electroadhesive pads comprise multiple pad elements arranged as a tiled system, and wherein the control unit and the power drive circuit are configured to energize the pad elements in coordination to induce electroadhesive attraction between the pad elements and the opposing surface.

13. A method of electroadhesive attachment and release in a microgravity environment, comprising:
applying, by a power drive circuit under control of a control unit, a drive signal to one or more pad elements of an electroadhesive pad system to induce electroadhesive attraction between the electroadhesive pad system and an opposing surface;
detecting, by a sensing unit electrically coupled to one or more conductors associated with the one or more pad elements, electrical signal characteristics resulting from interactions between the one or more pad elements and the opposing surface;
determining, by the control unit based on the electrical signal characteristics, an attachment state;
varying, by the control unit, one or more characteristics of the drive signal applied to the one or more pad elements based on the attachment state to modify electroadhesive attraction between the electroadhesive pad system and the opposing surface;
modifying the drive signal to reduce electroadhesive attraction to cause release of the electroadhesive pad system from the opposing surface;
applying an additional electrical signal to the one or more pad elements to reduce residual electric fields; and
reversing polarity of a signal applied to the one or more pad elements before a subsequent attachment cycle.

14. A method of electroadhesive attachment and release, comprising:
conducting an activation that comprises applying a drive signal to one or more electroadhesive pads to induce electroadhesive attraction between the one or more electroadhesive pads and an opposing surface; and
conducting a release that comprises modifying the drive signal to reduce electroadhesive attraction to cause release of the one or more electroadhesive pads from the opposing surface.

15. The method of claim 14, wherein modifying the drive signal comprises varying a voltage level or a waveform characteristic of the drive signal.

16. The method of claim 14, further comprising detecting electrical signal characteristics associated with the one or more electroadhesive pads and determining, based on the electrical signal characteristics, an attachment state.

17. The method of claim 16, wherein the electrical signal characteristics comprise: current draw, voltage response, capacitance, impedance, or contact potential.

18. The method of claim 16, further comprising modifying the drive signal based on the attachment state.

19. The method of claim 16, further comprising, responsive to determining an attachment state corresponding to attachment between the one or more electroadhesive pads and the opposing surface, conducting a hold that comprises applying a hold drive signal to energize the one or more electroadhesive pads to maintain electroadhesive attraction between the one or more electroadhesive pads and the opposing surface.

20. The method of claim 14, wherein the one or more electroadhesive pads comprise multiple pad elements arranged as a tiled system, and wherein applying the drive signal comprises applying one or more drive signals to energize the pad elements in coordination to induce electroadhesive attraction between the pad elements and the opposing surface.

21. The method of claim 14, further comprising applying an additional electrical signal to the one or more electroadhesive pads to reduce residual electric fields.

22. The method of claim 14, further comprising reversing polarity of a signal applied to the one or more electroadhesive pads before a subsequent attachment cycle.
